(19) United States
(12) Patent Application Publication
(10) Pub. No.: US 2014/0305283 A1
(43) Pub. Date: Oct. 16, 2014

(54) DRUM STICK

(71) Applicant: Joseph Roberts Risolia, Miami Beach, FL (US)

(72) Inventor: Joseph Roberts Risolia, Miami Beach, FL (US)

(21) Appl. No.: 13/863,892

(22) Filed: Apr. 16, 2013

(51) Int. Cl. G10D 13/00

(52) U.S. Cl. CPC G10D 13/003
USPC 84/422.4

(57) ABSTRACT

There is a drum stick including a shaft having a long axis. The drum stick includes an elongated magnet extending along the shaft and having a polar orientation not parallel to the long axis. The shaft includes an axial cavity and the elongated magnet is disposed therein. The drum stick includes a tip cap coupled to the shaft to serve as a drum stick tip.

### BACKGROUND OF THE INVENTION

1. Field of the Invention

The present invention relates to drumsticks, specifically to magnetic drumsticks.

2. Description of the Related Art

A drum stick is a type of percussion mallet used particularly for playing snare drum, drum kit and some other percussion instruments, and particularly for playing unpitched percussions. Specialized beaters used on some other percussion instruments, such as the metal beater or wand used with a triangle, and particularly beaters or mallets used with tuned percussion such as xylophone and tympani, are not normally referred to as drum sticks.

Drum sticks generally have all of the following characteristics: they are normally supplied and used in pairs; they are held in the hands, and most often one in each hand. They may be used to play at least some sort of drum (as well as other instruments) and are normally used only for untuned percussion. The most common and prototypical drum stick is turned from a single piece of wood, most commonly of hickory, less commonly of maple, and least commonly but still in significant numbers, of oak.

The tip or bead is the part most often used to strike the instrument. Tips of whatever material are of various shapes, including acorn, barrel, oval and round. The shoulder of the stick is the part that tapers towards the tip, and is normally slightly convex. It is often used for playing the bell of a cymbal, and for the loudest strokes on a wood block. It can also be used to produce a cymbal crash when applied to the bow or rim of a cymbal, and for playing ride patterns on china, swish and pang cymbals.

The shaft is the body of the stick, and is cylindrical for most applications including drum kit and orchestral work. It is used for playing cross stick and rim shots, and applied to the rim of a cymbal for the loudest cymbal crashes. The butt is the opposite end of the stick to the tip. Some rock musicians use it rather than the tip. Plain wooden drum sticks are most commonly described using a number to describe the weight and diameter of the stick followed by one or more letters to describe the tip. Drum sticks of the traditional form are also made from metal, carbon fiber and/or other materials.

Some improvements have been made in the field. Examples of references related to the present invention are described below in their own words, and the supporting teachings of each reference are incorporated by reference herein:

U.S. Pat. No.: 7,595,442, issued to Grover, discloses an ergonomic drumstick comprising a shaft member and a grip member including a load face portion, an apex portion, and a bore. The grip member ergonomically fits the profile of a user's fingers, enabling the user to retain the drumstick in a particular position and to play comfortably for extended periods of time. The ergonomic drumstick allows a relaxed grip, reducing the shock transfer to the user's hands, which in turn reduces fatigue. The ergonomic drumstick also can be fully adjustable, and reusable, with a grip selectable for fit, profile and size.

U.S. Pat. No.: 7,375,271, issued to Zelinsky, discloses an enhanced drum stick. The drum stick includes a grip attachment defining a closed loop which is secured to the drum stick by a bracket. The closed loop can be rigid or relatively flexible.

U.S. Pat. No.: 6,326,535, issued to Pokallus, discloses an improved drumstick of the type having a drumstick body having a butt end and a tipped end; an undercoating applied to the wall of at least a portion of the stick body to greatly enhance the foil layer adhering to the drumstick, a hot stamp foil layer applied against the undercoating so at least the tip end and the butt end of the drumstick remaining uncovered by the foil layer, the improved drumstick made from the process of providing the wooden drumstick; coating at least a portion of the wooden drumstick with a dye stain; the dye stained portion of the drumstick is treated with a lacquer undercoat; the dye stained portion of the drumstick is covered with a hot stamp foil, including the tapered portion of the drumsticks; and providing a clear protective topcoat to the entire drumstick. The butt end and tip ends of the drumstick are maintained natural. Further there is provided a compressed portion of the drumstick for providing greater striking strength. Further there is included the step of stamping a logo on the hot stamp foil which covers the drumstick surface.

U.S. Pat. No.: 5,199,621, issued to McLennan, discloses a holster storing a number of drumsticks—or mallets or other rigid beaters of percussion instruments—for instant and speedy withdrawal by a percussion player during performance if a drumstick needs to be suddenly replaced or added. The holster is a trapezoidal plate, typically of leather, provided with two rows of elastic loops, each row having the same number of identical loops. One row is formed along the long parallel side with wide loop spacing, and the other row along the short parallel side with close loop spacing. Each stored drumstick is inserted through two corresponding opposed loops, one in each row, with the striking end of the drumstick near a close spaced loop. The differential loop spacing between the rows causes the stored drumsticks to radiate out holding end first, and also deforms all loops to grip the drumsticks. The radiating out also causes the drumstick holding ends to be well spread apart for convenient withdrawal of a given drumstick without disturbing its neighbors. Withdrawal by hand easily overcomes the gripping action of the loops. The holster can be attached to any suitable body part—hips, thigh, leg, arm, etc.—by body straps, typically of nylon. Also, the holster can be ornamented and carry any desired insignia. Several holsters can be used in combination.

U.S. Pat. No.: 6,146,324, issued to Engel, discloses a therapeutic magnetic and analgesic pad or bandage formed of opposed strips interconnected to define a space or pocket therebetween for receiving a plurality of permanent magnets for generating a magnetic field to effect healing and/or reducing pain of an injured body part. The strip of the bandage or pad adapted to be placed in contact with the injured body part is formed of a synthetic water insoluble resin material which is impregnated with an analgesic ingredient in a manner whereby the analgesic ingredient is gradually released in a dry volatile state and imparted to the injured body part to synergistically further minimize pain and enhance healing.

The inventions heretofore known suffer from a number of disadvantages which include being limited in use, being unable to magnetically couple together, being limited in couple-ability, being expensive, failing to improve the health of the user, not coupling together, resulting in lost sticks, not being able to pick up items therewith, not extending ones reach, not being able to be used in multiple manners, only being usable as drumsticks, being limited in sound effects that can be created therewith, being limited in interesting tricks that may be performed therewith.

What is needed is a drum stick that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available drum sticks. Accordingly, the present invention has been developed to provide a pair of drum sticks configured to magnetically couple together or magnetically couple to a metal object, such as a drum.

According to one embodiment of the invention, there is a drum stick that may include a shaft that may have a long axis. The drum stick may include an elongated magnet that may be extending along the shaft and may have a polar orientation not parallel to the long axis. The shaft may include an axial cavity and the elongated magnet may be disposed therein. The elongated magnet may be wrapped about the shaft. The shaft may consist essentially of the elongated magnet. The elongated magnet may consist essentially of magnetized particles that may be embedded in the shaft. The drum stick may include a tip cap that may be coupled to the shaft to serve as a drum stick tip.

According to one embodiment of the invention, there is a drum stick that may consist of a tip and a shoulder that may be coupled to the tip. The drum stick may include a shaft that may be coupled to the shoulder and may have a long axis. The drum stick may include an elongated magnet that may be extending along the shaft and may have a polar orientation not parallel to the long axis.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a pair of drum sticks coupled to a refrigerator, coupled to a drum, and being coupled together and then pulled apart, according to one embodiment of the invention;

FIG. 2 is a side elevational view of a pair of drum sticks showing alternative polar orientations thereof, according to one embodiment of the invention;

FIG. 3 is a side cross-sectional view of a drum stick, according to one embodiment of the invention;

FIG. 4 is a partial side cross-sectional view of a drum stick, according to one embodiment of the invention; and

FIG. 5 is a side cross-sectional view of a drum stick, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

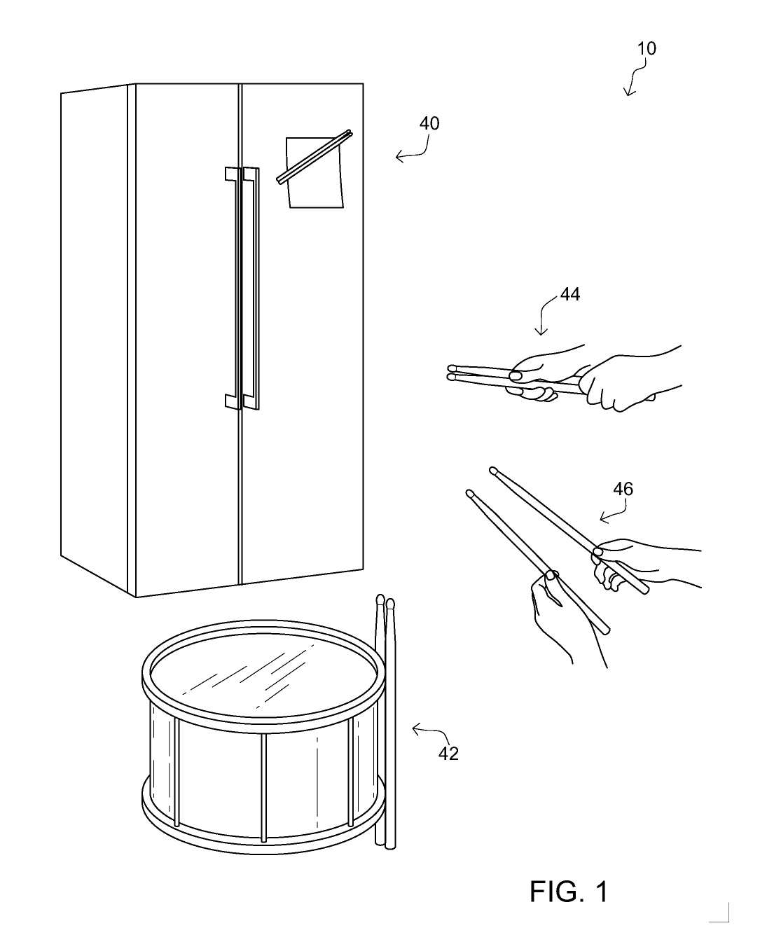

FIG. 1 illustrates a pair of drum sticks coupled to a refrigerator, coupled to a drum, and being coupled together and then pulled apart, according to one embodiment of the invention. There is shown a pair of drum sticks 10 magnetically coupled to a refrigerator 40, magnetically coupled to a drum set 42, magnetically coupled together 44 and a pair of drum sticks 10 uncoupled 46.

The illustrated drum stick 10 is configured to magnetically couple to another drum stick or couple to a magnetic or metal material. The drum stick 10 is configured to selectably couple to a refrigerator 40; wherein the drum stick 10 is used to support an object against a metal surface of the refrigerator. The illustrated drum stick 10 is configured to selectably couple to a percussion instrument, such as a drum set 42. The drum stick 10 is configured to selectably couple to a metal surface of the drum set, for storage of the drum stick 10 when not in use. Coupling the drum stick 10 to the drum set reduces the chances of losing or misplacement of the drum sticks when not in use. The illustrated drum stick 10 is configured to selectably couple 44 and selectably uncouple 46 to another drum stick, thereby reducing the chance of misplacing or losing one of the drumsticks.

The illustrated drum stick 10 is configured to play a percussion type of musical instrument. The drum stick 10 includes magnetic properties disposed therein. There may be a permanent magnet coupled to and/or integrated within each drum stick 10. The magnetic elements may generate a magnetic field through the fingers and/or hand of a user when in use. It is theorized, without limitation to any particular theory of operation, that the magnetic field lines operate on the systems of the body to enhance health of a user, such as but not limited to enhancing blood flow, enhancing the operation of material exchange at the blood cell level, facilitating the migration of resources to cells, and/or enhancing cell membrane operation. There may be more than one magnet or magnetic elements coupled and/or disposed on or in each drum stick 10. The drum stick 10 may be constructed of a hard ferromagnetic material. The shape and/or size of the magnetic elements may be selected to alter a flexibility characteristic of the drum stick and thereby alter play characteristics when in use.

There may be a method of therapy including one or more of the steps of providing a magnetic drum stick 10 and playing a percussion type instrument using the provided magnetic drum stick 10. There may be a step of measuring a health indicator, such as but not limited to blood flow, nutrient transfer, oxygen level, and the like of an area of the body associated with operation of the magnetic drum stick, such as but not limited to a hand or fingers/thumb. There may be a step of providing a second magnetic drum stick having a different characteristic then the first magnetic drum stick, such as but not limited to magnet strength, magnet size, pick flexibility, and the like, wherein the characteristic is chosen based on a measured health indicator.

In one non-limiting example, there is a drum stick having a magnetized portion that has a polar orientation that is not parallel with the long axis of the stick. Such may include having a polar orientation that is between about two of 5, 10, 15, 20, 25, 30, 35, 40, 45, 50, 55, 60, 65, 70, 75, 80, 85, and 90 degrees from parallel with the long axis of the stick. Accordingly such sticks may provide a higher magnetic flux about the vicinity of the shafts, which is where they are held during use and which is where they would be coupled together during storage and/or during uses that are not directly related to drumming. Such a polar orientation might also be non-orthogonal to the long axis of the stick, thereby having components that are along both the long axis and a plane orthogonal to the long axis. Advantageously, such a structure may have beneficial properties about the shaft while still having significant magnetic flux about the tip of the drum-stick.

In another embodiment, the stick includes two magnetized regions having different polar orientations. Such may include, but is not limited to having a magnetized tip oriented (polar) substantially parallel to the long axis of the stick and a magnetized shaft region oriented (polar) substantially orthogonal to the long axis of the stick.

Non-limiting examples of magnetic materials that may be utilized herein include: permanent magnets, electromagnets, injection molded magnets, flexible magnets, Neodymium Iron Boron (NdFeB or NIB) magnets, Samarium Cobalt (SmCo) magnets, Alnico magnets, Ceramic magnets, Ferrite magnets, and the like and combinations thereof. Such magnets may be formed into a desired shape, such as but not limited to shapes described herein and then may be magnetized to a particular polar orientation, such as but not limited to those described herein.

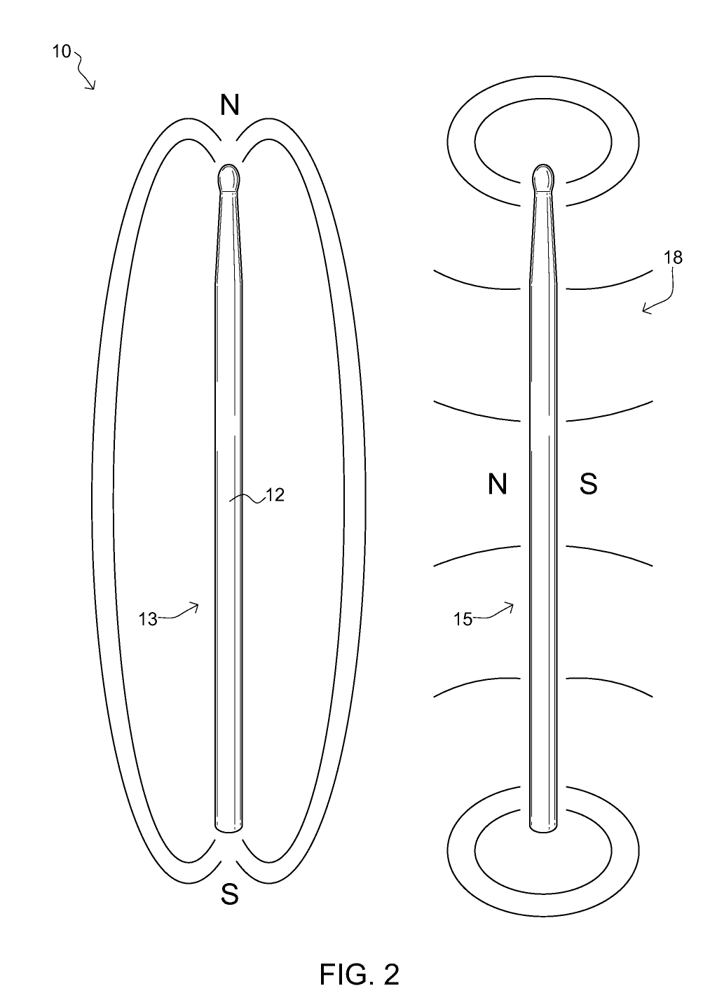

FIG. 2 is a side elevational view of a pair of drum sticks showing alternative polar orientations thereof, according to one embodiment of the invention. There is shown a pair of drum sticks 10 each including a shaft 12. The left drum stick 13 has a polar orientation that is substantially parallel to the long axis of the stick, wherein north is at one end and south is at the other. The right drum stick 15 has a polar orientation that is substantially orthogonal to the long axis of the stick, thereby not substantially parallel thereto, and substantially parallel to a plane that is orthogonal to the long axis of the stick.

The illustrated drum stick 10 includes a shaft 12. The shaft 12 is configured to enable a user to grip and manipulate the drum stick 10 during use, such as playing a percussion type of instrument. Each of the illustrated drum sticks 10 include an elongated magnet disposed therein, and having a polar orientation 18 as shown. The elongated magnet may consist essentially of magnetized particles that are embedded in the shaft 12 of the drum stick 10. The elongated magnet may be disposed within a cavity through the drum-stick, may be a sleeve covering the shaft of the drum stick, or may be a combination thereof.

In one embodiment of the invention, the magnetic elements are oriented with field lines extending outward from a long axis of the drum stick. The magnetic elements are configured to generate a magnetic field through the fingers and/or hand of a user when in use. It is theorized, without limitation to any particular theory of operation, that the magnetic field lines operate on the systems of the body to enhance health of a user, such as but not limited to enhancing blood flow, enhancing the operation of material exchange at the blood cell level, facilitating the migration of resources to cells, and/or enhancing cell membrane operation. There may be more than one magnet or magnetic elements coupled and/or disposed on or in each drum stick. The shape and/or size of the magnetic elements may be selected to alter a flexibility characteristic of the drum stick and thereby alter play characteristics when in use.

According to one embodiment of the invention, there may be a method of therapy including one or more of the steps of providing a magnetic drum stick and playing an instrument using the provided magnetic drum stick. There may be a step of measuring a health indicator, such as but not limited to blood flow, nutrient transfer, oxygen level, and the like of an area of the body associated with operation of the magnetic drum stick, such as but not limited to a hand or fingers/thumb. There may be a step of providing a second magnetic drum stick having a different characteristic, such as but not limited to magnet strength, magnet size, pick flexibility, and the like, wherein the characteristic is chosen based on a measured health indicator.

In one non-limiting example, there is a magnetic field inducing material or system disposed within a drum stick. Such may include but is not limited to small formed magnets (cubes, cylinders, etc.) that may be sized similar to grains of sand or dust, magnetized paste, magnetic plastics, and/or looped electric currents that form magnetic fields, and the like and combinations thereof.

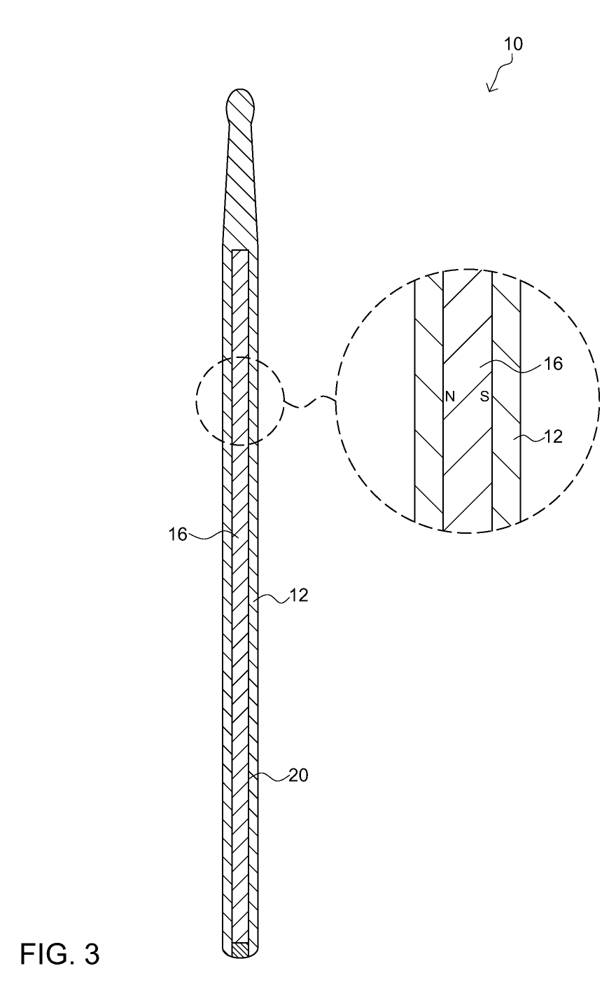

FIG. 3 is a side cross-sectional view of a drum stick, according to one embodiment of the invention. There is shown a drum stick 10 including a shaft 12 and an elongated magnet 16 disposed within an axial cavity 20.

The illustrated drum stick 10 includes a shaft 12 having a long axis. The drum stick 10 includes an elongated magnet 16 extending along the shaft 12 and having a polar orientation not parallel to the long axis. The shaft 12 includes an axial cavity 20, wherein the elongated magnet 16 is disposed therein. The axial cavity 20 is sized and shaped to be slightly longer and wider than the elongated magnet 16. The elongated magnet 16 is sized and shaped to fit within the axial cavity 20, wherein there is minimal movement of the elongated magnet 16 when disposed within the axial cavity 20 and also when being used. The elongated magnet 16 is configured to be selectably removable from the axial cavity 20 of the shaft 12. The user may replace the shaft after being worn and damaged during use and use the same elongated magnet 16 in a new shaft. The user may also replace the elongated magnet 16 within the shaft 12 to adjust the magnetic strength of the elongated magnet and the health benefits associated therewith. As illustrated, the elongated magnet 16 includes a left side having a polar orientation opposite of a right side of the elongated magnet 16.

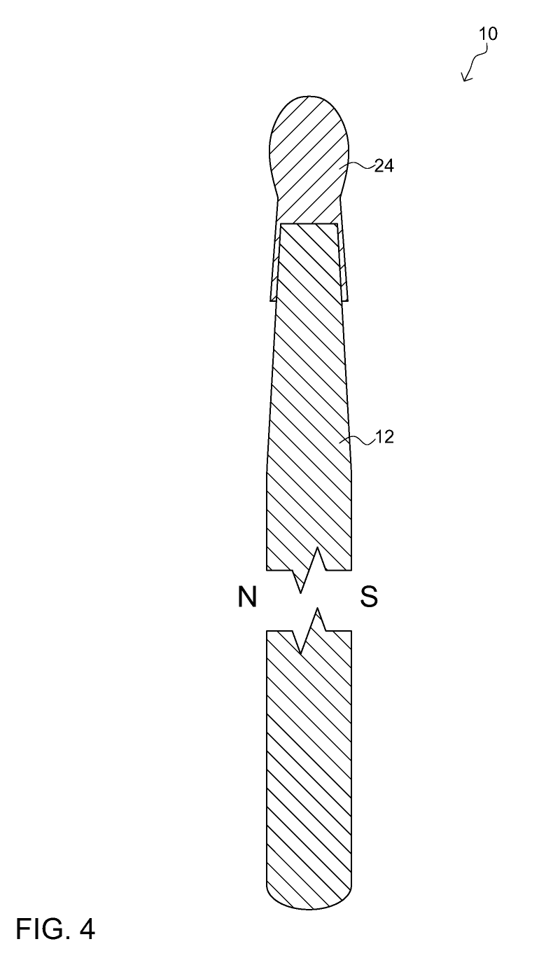

FIG. 4 is a partial side cross-sectional view of a drum stick, according to one embodiment of the invention. There is shown a drum stick 10 including a shaft 12 and a tip cap 24.

The illustrated drum stick 10 includes a shaft 12. The drum stick includes an elongated magnet having a polar orientation. The illustrated shaft 12 consists essentially of the elongated magnet. The elongated magnet may consist essentially of magnetized particles that are embedded in the shaft 12. The illustrated shaft 12 includes a polar orientation on a first side of the drum stick and an opposite polar orientation on a second side of the drum stick, opposite of the first side. The illustrated drum stick 10 includes a tip cap 24 coupled to the shaft 12 to serve as a drum stick tip. The tip cap 24 is configured to be selectably interchangeable depending on the type of sound preferred by the user. The tip cap 24 may include varying degrees of hardness to create varying sounds on a percussion instrument.

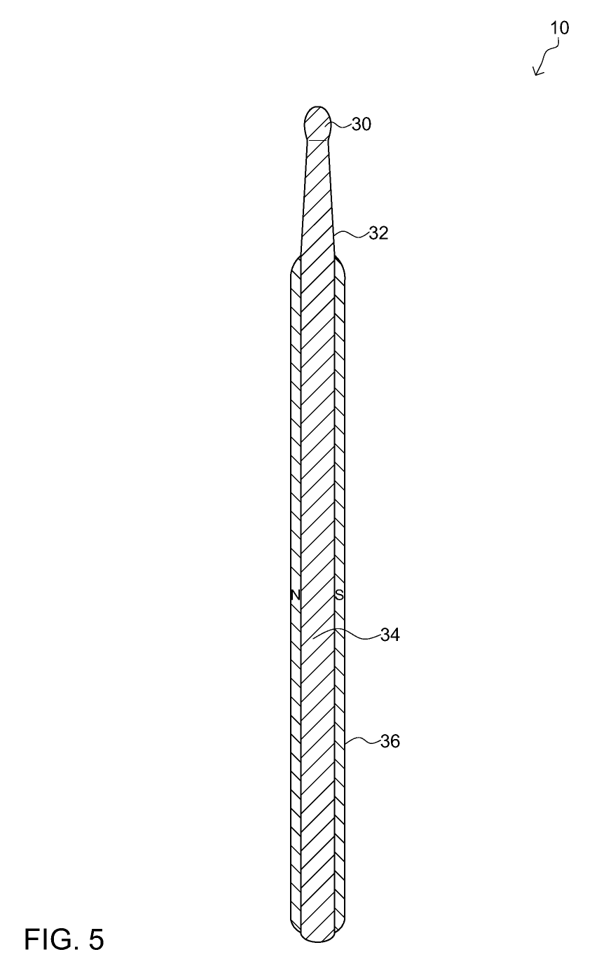

FIG. 5 is a side cross-sectional view of a drum stick, according to one embodiment of the invention. There is shown a drum stick 10 including a tip 30, a shoulder 32, a shaft 34, and an elongated magnet 36.

The illustrated drum stick consists of a tip 30 configured to strike a percussion instrument to create a musical sound. The drum stick includes a shoulder 32 coupled to the tip 30; wherein the shoulder 32 is configured to provide support to the tip 30 during use. The drum stick 10 includes a shaft 34 coupled to the shoulder 32 and having a long axis. The illustrated drum stick 10 includes an elongated magnet 24 wrapped about the shaft 34 of the drum stick 10. The elongated magnet 24 is configured to have a polar orientation not parallel to the long axis. The illustrated elongated magnet includes a polar orientation disposed about a first side of the shaft 34 and an opposite polar orientation disposed about a second side of the shaft 34.

### STATEMENTS OF THE INVENTION

1. A drum stick comprising;
a) a shaft having a long axis; and
b) an elongated magnet extending along the shaft.
2. A drum stick according to claim 1 wherein the magnet has a polar orientation which is not parallel to the long axis.
3. A drum stick according to claim 1 or 2, wherein the shaft is provided with an axial cavity and the elongated magnet is disposed within the cavity.
4. A drum stick according to claim 1 or 2, wherein the elongated magnet is wrapped about the shaft.
5. A drum stick according to any preceding claim, further comprising a tip cap coupled to the shaft to provide a drum stick tip.
6. A drum stick according to either of claim 1, 2 or 5, wherein the shaft consists of the elongated magnet.
7. A drumstick according to any preceding claim, wherein the elongated magnet consists essentially of magnetized particles embedded in the shaft.
8. A drum stick according to any preceding claim wherein the shaft is coupled to a shoulder and the shoulder is coupled to a tip.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate orthogonal alternative polar orientations, it is understood that a polar orientation of a magnetized drum stick might not be exactly orthogonal.

Additionally, although the figures illustrate specific head shapes for drum sticks, it is understood that the head shapes for drum sticks are plethoric and may vary greatly while still being within the scope of the claimed invention.

It is expected that there could be numerous variations of the design of this invention. An example is that the shaft may have a cross-section that is other than circular, such as but not limited to being oval, elliptic, polygonal, star-shaped, irregularly shaped, and the like and combinations thereof.

Finally, it is envisioned that the components of the device may be constructed of a variety of materials, including but not limited to metals, ceramics, rubbers, resins, polymers, plastics, wood, fibers, woven fibers, and the like and combinations and composites thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

1. A drum stick, comprising:
a) a shaft having a long axis; and
b) an elongated magnet extending along the shaft and having a polar orientation not parallel to the long axis.

2. The drum stick of claim 1, wherein the shaft includes an axial cavity and the elongated magnet is disposed therein.

3. The drum stick of claim 1, wherein the elongated magnet is wrapped about the shaft.

4. The drum stick of claim 1, further comprising a tip cap coupled to the shaft to serve as a drum stick tip.

5. The drum stick of claim 1, wherein the shaft consists essentially of the elongated magnet.

6. The drumstick of claim 1, wherein the elongated magnet consists essentially of magnetized particles embedded in the shaft.

7. A drum stick, comprising:
a) a shaft having a long axis; and
b) an elongated magnet extending along the shaft.

8. The drum stick of claim 7, wherein the elongated magnet includes a polar orientation not parallel to the long axis.

9. The drum stick of claim 8, wherein the shaft includes an axial cavity and the elongated magnet is disposed therein.

10. The drum stick of claim 9, wherein the elongated magnet is wrapped about the shaft.

11. The drum stick of claim 10, further comprising a tip cap coupled to the shaft to serve as a drum stick tip.

12. The drum stick of claim 11, wherein the shaft consists essentially of the elongated magnet.

13. The drumstick of claim 12, wherein the elongated magnet consists essentially of magnetized particles embedded in the shaft.

14. A drum stick, consisting of:
a) a tip;
b) a shoulder coupled to the tip;
c) a shaft coupled to the shoulder and having a long axis; and
d) an elongated magnet extending along the shaft and having a polar orientation not parallel to the long axis.
